(19) United States
(12) Patent Application Publication
(10) Pub. No.: US 2017/0346843 A1
(43) Pub. Date: Nov. 30, 2017

(54) BEHAVIOR PROCESSING METHOD AND DEVICE BASED ON APPLICATION PROGRAM

(71) Applicant: BEIJING QIHOO TECHNOLOGY COMPANY LIMITED, BEIJING (CN)

(72) Inventor: HAOQIU ZHANG, BEIJING (CN)

(73) Assignee: BEIJING QIHOO TECHNOLOGY COMPANY LIMITED, BEIJING (CN)

(21) Appl. No.: 15/536,773

(22) PCT Filed: Nov. 24, 2015
(86) PCT No.: PCT/CN2015/095454

§ 371 Date: Jun. 16, 2017

(30) Foreign Application Priority Data
Dec. 16, 2014 (CN) 2014107847269

(51) Int. Cl. H04L 29/06; G06F 21/44

(52) U.S. Cl. CPC H04L 63/1425; H04L 63/1416; G06F 21/44; H04L 63/101

(57) ABSTRACT

The disclosure discloses a behavior processing method and device based on application program. The method comprises: when a startup operation of an application program is detected, acquiring behavior authorization information corresponding to the application program; monitoring behavior information of the application program; and processing the behavior information according to the behavior authorization information. An embodiment of the disclosure monitors an application program taking a single behavior as an authorization unit by configuring authorization information for behaviors, thus avoiding monitoring leaks caused by uniform configuration of authorization for the application program in a whitelist and a backlist, so as to realize fine-gained authorization control, enhance the strength of protection, reduce potential threats, and also make it possible to reduce a false alarm rate.

### CROSS-REFERENCE TO RELATED APPLICATIONS

This application is the national stage of International Application No. PCT/CN2015/095454 filed Nov. 24, 2015, which is based upon and claims priority to Chinese Patent Application No. CN201410784726.9, filed Dec. 16, 2014, the entire contents of all of which are incorporated herein by reference.

### TECHNICAL FIELD

The disclosure relates to the technical field of application programs, and in particular to a behavior processing method based on application program and a behavior processing device based on application program.

### BACKGROUND

With the continuous development of Internet technology, people have developed various application programs with rich functions, such as instant messaging tools, audio players, video players, calendar tools and so on, which bring many convenience to people's life.

For various reasons, application programs always will have certain leaks, with use of which viruses, Trojan horse or malicious code can manipulate the application programs to perform illegal abuse, also or, the application programs themselves perform some dangerous behaviors for some illegal purposes.

Furthermore, behaviors of the application programs possibly will endanger the integrity, confidentiality, usability and controllability of data, which is finally represented as departing from normal orbits during the running of the application programs, i.e. generating abnormal behaviors.

To protect the security of data, a user generally installs a security tool such as a firewall, an antivirus tool and the like in an operation system. These security tools generally will be provided with a blacklist and a whitelist, protecting the operation system by adopting the core concept of “black-or-white”.

Specifically, for trusted application programs in the whitelist, all the trusted application programs are allowed to perform operations; and for untrusted application programs in the blacklist, behaviors of the untrusted application programs will be examined, and sensitive behaviors, if appear, will be prompted to the user in a popup window form.

For blacklist-and-whitelist mechanism, all behaviors of an application program added into the whitelist are trusted, thus making occurrence of leaks easy. If an application program is not added into the whitelist, there are possibly many behaviors with false alarm of viruses, causing many error operations and wastage of system resources.

For example, a certain application program is a text-edited program and is mainly used for editing, storing and printing documents, and normal behaviors of the application program are represented as reading and writing documents in document formats supported by the application program and operating a printer to perform printing. If it is found that the application program downloads an executable program via a network and sets it as being run automatically upon startup by modifying a register table, this is obviously an abnormal behavior, which is possibly caused for having been attacked by macro viruses or Trojan programs, also or, caused because the application program itself has this abnormal behavior for the purpose of forcibly popularizing the application program.

If the text-edited program is added into the whitelist, the above abnormal behavior is also allowed, thus causing a security leak. If it is not added into the whitelist, daily behaviors such as reading and writing of documents, printing by a printer and the like are easily misreported as viruses.

### SUMMARY

In view of the foregoing defect, the disclosure is proposed to provide a behavior processing method based on application program and a corresponding behavior processing device based on application program which overcome the foregoing defect or at least partially solve or mitigate the foregoing defect.

According to one aspect of the disclosure, a behavior processing method based on application program is provided, comprising steps of:

when a startup operation of an application program is detected, acquiring behavior authorization information corresponding to the application program;
monitoring behavior information of the application program; and
processing the behavior information according to the behavior authorization information.

According to another aspect of the disclosure, a behavior processing device based on application program is provided, comprising:

one or more processors; and

a memory;

wherein one or more programs are stored in the memory, and when executed by the one or more processors, the one or more programs cause the one or more processors to:

when a startup operation of an application program is detected, acquire behavior authorization information corresponding to the application program;

monitor behavior information of the application program; and

process the behavior information according to the behavior authorization information.

According to yet another aspect of the disclosure, a computer program is provided, comprising a computer readable code that, when run on a computing device, causes the computing device to execute the behavior processing method based on application program described above.

According to still another aspect of the disclosure, a non-transitory computer-readable medium is provided, the non-transitory computer-readable medium having computer programs stored thereon that, when executed by one or more processors of an electronic device, cause the electronic device to perform operations for processing behavior based on application program, the operations comprising:

when a startup operation of an application program is detected, acquiring behavior authorization information corresponding to the application program;

monitoring behavior information of the application program; and

processing the behavior information according to the behavior authorization information.

The disclosure produces the following advantageous effects:

An embodiment of the disclosure acquires behavior authorization information corresponding to an application program when a startup operation of the application program is detected, processes monitored behavior information of the application program according to the behavior authorization information, and monitors an application program taking a single behavior as an authorization unit by configuring behavior authorization information for behaviors, thus avoiding monitoring leaks caused by uniform configuration of authorization for the application program in a whitelist and a backlist, so as to realize fine-gained authorization control, enhance the strength of protection, reduce potential threats, and also reduce a false alarm rate.

An embodiment of the disclosure updates and maintains behavior authorization information of an application program at a server, without needing to locally configure behavior authorization information of different application programs, thus reducing resources occupied by a local system, such that the server can rapidly make a response to a behavior change of the application program to modify the behavior authorization information, thus ensuring the accuracy of the behavior authorization information.

An embodiment of the disclosure locally configures behavior authorization basic information, which is configured according to behavior authorization configuration information sent by a server, so as to obtain behavior authorization information of an application program. On the one hand, local authorization basic information can be obtained by acquiring an authorization group identifier from the server, making it unnecessary to acquire part of the behavior authorization information repeatedly from the server, thus reducing the transmission amount of data greatly, reducing occupied bandwidths and increasing a transmission speed of data; on the other hand, the server can timely make a feedback to a behavior change of the application program, and modify the behavior authorization configuration information, thus ensuring the accuracy of the behavior authorization information of the application program.

An embodiment of the disclosure performs authentic and unauthentic operations on behaviors of an application program according to whitelist behavior information and blacklist behavior information, so as to further fine the hierarchy of authority, thereby improving the accuracy of behavior monitoring.

An embodiment of the disclosure gives a prompt as to an unmarked behavior, or, analyzes an unmarked behavior by a server, thereby further improving the accuracy and the comprehensiveness of behavior monitoring.

The above descriptions are only a brief summary of the technical solution of the disclosure. For more clear comprehension of the technical means of the disclosure, the disclosure may be carried out in accordance with the contents of the description; and to enable the above and other objects, features and advantages of the disclosure to be more apparent and intelligible, detailed embodiments of the disclosure are hereby provided below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the present invention. And in the whole drawings, same drawing reference signs are used for representing same components. In the drawings:

FIG. 1 schematically illustrates a schematic view of step flow of an embodiment of a behavior processing method based on application program according to one embodiment of the disclosure;

FIG. 2 schematically illustrates a block schematic view of an embodiment of a behavior processing device based on application program according to one embodiment of the disclosure;

FIG. 3 schematically illustrates a block diagram of a computing device for executing the method according to the disclosure; and

FIG. 4 schematically illustrates a storage unit for retaining or carrying a procedure code for implementing the method according to the disclosure.

### DETAILED DESCRIPTION

Hereinafter, the disclosure is further described in combination with the drawings and the detailed embodiments.

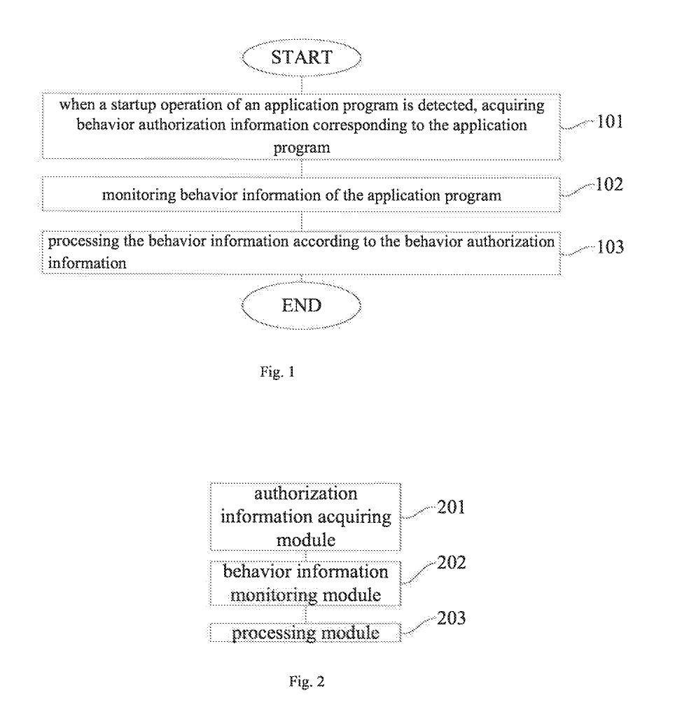

Referring to FIG. 1, a schematic view of step flow of an embodiment of a behavior processing method based on application program according to one embodiment of the disclosure, which specifically may comprise the following steps 101-103, is schematically illustrated.

Step 101, when a startup operation of an application program is detected, acquiring behavior authorization information corresponding to the application program acquired.

In the embodiment of the disclosure, an application program currently started may be triggered through a user's operation (for example, a user triggers startup of an application program by double-clicking a shortcut with a mouse by a user), may also be triggered by other application programs or services (for example, when a download tool completes download of a file, a security tool may be invoked to perform a security scan on the file), and may also be started in other manners. The embodiment of the disclosure will not make any limitations hereto.

In detailed implementation, it is possible to, by a system function specified in a callback operation system, such as PsSetCreateProcessNotifyRoutine and so on, cause the operation system to notify the system function, so as to know information such as process start and exit of an application program and so on.

Of course, in the embodiment of the disclosure, it is also possible to acquire a timing and information of process startup of an application program by Hooking a system function such as CreateProcess and so on. The embodiment of the disclosure will not make any limitations hereto.

Upon detection of startup of an application program, a client can acquire behavior authorization information corresponding to the application program, so as to control a behavior of the application program, wherein the behavior authorization information can be used for recording an authorization of a behavior of the corresponding application program.

In an alternative embodiment of the disclosure, the step 101 may comprise the following sub-steps S11-S13.

Sub-step S11, extracting first feature information of the application program.

Upon detection of startup of an application program, a client can extract first feature information thereof.

The first feature information may be information representing a feature of an application program currently started, and specifically may comprise ID (Identity), digital signature, hash (hash value) and so on.

Sub-step S12, sending the first feature information to a server.

By applying the embodiment of the disclosure, second feature information of an application program to be detected can be extracted in advance, and the second feature information may be information representing the application program to be detected, and specifically may comprise ID (Identity), digital signature, hash (hash value) and so on.

In addition, a behavior of the application program to be detected may be analyzed in advance/in real time, so as to configure authorization information for second feature information of the application program according to an analysis result. An authorization owned by a behavior of an application program corresponding to the second feature information may be recorded in the behavior authorization information. The behavior authorization information may be used for monitoring a behavior of the application program.

Specifically, the behavior authorization information may comprise at least one of whitelist behavior information and blacklist behavior information. Of course, for some application programs, behavior authorization information thereof may comprise only whitelist behavior information, or, may comprise only blacklist behavior information. The embodiment of the disclosure will not make any limitations hereto.

Upon analysis that a behavior of the application program to be detected is authentic, behavior information of the behavior is added as feature behavior information into whitelist behavior information corresponding to its second feature information, that is, whitelist behavior information may be a set of authentic behaviors of a certain application program.

Upon analysis that a behavior of the application program to be detected is unauthentic, behavior information of the behavior is added as feature behavior information into blacklist behavior information corresponding to its second feature information, that is, blacklist behavior information may be a set of unauthentic behaviors of a certain application program.

In actual applications, the application program to be detected may comprise application programs involving an alarm behavior which are uploaded by a user. The application program to be detected is placed to be run in a virtual machine, and involves alarm behaviors repeatedly, wherein if no abnormal behaviors are found, behaviors represented at that time for which an alarm will be given can be added to whitelist behavior information corresponding to second feature information of the application program.

Of course, a person skilled in the art may also initiatively collect different application programs for analysis. The embodiment of the disclosure will not make any limitations hereto.

Sub-step S13, receiving a behavior authorization information corresponding to preset second feature information, which is returned by the server when it is judged that the first feature information matches with the second feature information.

In the embodiment of the disclosure, a client may send first feature information to a server, and it is detected by the server whether the first feature information matches with preset second feature information.

When the first feature information matches with the second feature information, it may be represented that the application program currently started has been analyzed previously, and the behavior authorization information is stored.

The server sends behavior authorization information corresponding to the second feature information to a client, and the client monitors a behavior of the application program currently started.

The embodiment of the disclosure updates and maintains behavior authorization information of an application program at a server, without needing to locally configure behavior authorization information of different application programs, thus reducing resources occupied by a local system, such that the server can rapidly make a response to a behavior change of the application program to modify the behavior authorization information, thus ensuring the accuracy of the behavior authorization information.

In another alternative embodiment of the disclosure, the step 101 may comprise the following sub-steps S21-S25.

Sub-step S21, extracting first feature information of the application program.

Sub-step S22, sending the first feature information to a server.

Sub-step S23, receiving behavior authorization configuration information and an authorization group identifier corresponding to preset second feature information, which are returned by the server when it is judged that the first feature information matches with the second feature information.

Sub-step S24, seeking for behavior authorization basic information corresponding to the authorization group identifier, which is preset locally.

Sub-step S25, performing configuration on the behavior authorization basic information using the behavior authorization configuration information so as to obtain behavior authorization information.

In the embodiment of the disclosure, one or more authorization groups may be divided for application programs, each authorization group having a unique authorization group identifier to perform recognition.

Application programs in each authorization group possibly have identical or similar behaviors; however, a behavior of each application program generally also has a difference.

For example, both a download tool A and a download tool B will voluntarily modify power-on startup items, and will also upload data at the background; however, the download tool A performs upload via a 80 port while the download tool B performs upload via a 21 port, and besides, the download tool B will also invoke a security tool to perform a security scan on a downloaded file, so the download tool A and the download tool B can be subordinate to an identical authorization group.

Thus in the one hand, behavior authorization basic information may be configured for each authorization group, and in behavior authorization basic information, authorizations owned by identical or similar behaviors of the application programs in the authorization group may be recorded.

Specifically, the behavior authorization basic information may comprise at least one of whitelist behavior basic information and blacklist behavior basic information.

Wherein, the whitelist behavior basic information may be a set of authentic, identical or similar behaviors of the application programs in the authorization group; the blacklist behavior basic information may be a set of unauthentic, identical or similar behaviors of the application programs in the authorization group.

For example, for the download tool A and the download tool B, since uploaded data are generally used for P2P (Peer-to-Peer) data transmission, all the uploaded data are authentic; voluntarily modifying power-on startup items is not voluntarily requested by a user, and will occupy system resources and thereby lower a power-on speed, so all the voluntarily modified power-on startup items are unauthentic. For authorization groups to which the download tool A and the download tool B are subordinate, uploaded data may be written into the whitelist behavior basic information, and the voluntarily modified power-on startup items may be written into the blacklist behavior basic information.

It should be noted that a person skilled in the art can perform setting for the whitelist behavior basic information and the blacklist behavior basic information according to actual circumstances. For example, a behavior of invoking a security tool by the download tool B is authentic, and if most of other application programs in the authorization group do not have this behavior, this behavior may not be written into the whitelist behavior basic information. The embodiment of the disclosure will not make any limitations hereto.

On the other hand, behavior authorization configuration information may be configured for a specific application program, and in the behavior authorization configuration information, how to perform configuration for behavior authorization basic information of an authorization group to which the specific application program is subordinate may be recorded, so as to obtain behavior authorization information of the specific application program.

Specifically, the behavior authorization configuration information comprises at least one of whitelist behavior addition information, whitelist behavior deletion information, whitelist behavior modification information, blacklist behavior addition information, blacklist behavior deletion information, and blacklist behavior modification information.

Wherein the whitelist behavior addition information may indicate adding specified feature behavior information in whitelist behavior basic information;

the whitelist behavior deletion information may indicate deleting specified feature behavior information in whitelist behavior basic information;

the whitelist behavior modification information may indicate modifying specified feature behavior information in whitelist behavior basic information;

the blacklist behavior addition information may indicate adding specified feature behavior information in blacklist behavior basic information;

the blacklist behavior deletion information may indicate deleting specified feature behavior information in blacklist behavior basic information;

the blacklist behavior modification information may indicate modifying specified feature behavior information in blacklist behavior basic information.

For example, if the behavior authorization basic information of the authorization groups to which the download tool A and the download tool B are subordinate is as follows:

whitelist behavior basic information: uploading data (* port);

blacklist behavior basic information: voluntarily modifying power-on startup items;

where, * is wildcard, and uploading data (* port) may represent that any port is allowed to upload data,

then for the download tool A, on the basis of the behavior authorization basis information, it may be required to configure whitelist behavior modification information, so as to modify “uploading data (* port)” to “uploading data (80 port)”, that is, use of 80 port to upload data is authentic; and for the download data B, on the basis of the behavior authorization basis information, it may be required to configure whitelist behavior modification information, so as to modify “uploading data (* port)” to “uploading data (21 port)”, that is, use of 21 port to upload data is authentic, and meanwhile whitelist behavior addition information is configured to add “invoking security tool” in whitelist behavior basic information, such that a behavior of invoking a security tool to perform a security scan on a downloaded file is authentic.

An embodiment of the disclosure locally configures behavior authorization basic information, which is configured according to behavior authorization configuration information sent by a server, so as to obtain behavior authorization information of an application program. On the one hand, local authorization basic information can be obtained by acquiring an authorization group identifier from the server, making it unnecessary to acquire part of the behavior authorization information repeatedly from the server, thus reducing the transmission amount of data greatly, reducing occupied bandwidths and increasing a transmission speed of data; on the other hand, the server can timely make a feedback to a behavior change of the application program, and modify the behavior authorization configuration information, thus ensuring the accuracy of the behavior authorization information of the application program.

In an alternative example of the embodiment of the disclosure, the sub-step S25 may comprise the following sub-steps:

sub-step S251, adding feature behavior information corresponding to the whitelist behavior addition information in the whitelist behavior basic information.

In the embodiment of the disclosure, if the whitelist behavior addition information is received, specified behavior information (i.e., feature behavior information) may be added in the whitelist behavior basic information.

For example, if the whitelist behavior addition information is “w+modifying startup items”, where “w” may indicate the whitelist behavior basic information, “+” may indicates an addition operation and “modifying startup items” may be feature behavior information, then a behavior of modifying startup items is added in the whitelist behavior basic information.

In an alternative example of the embodiment of the disclosure, the sub-step S25 may comprise the following sub-steps:

sub-step S252, deleting feature behavior information corresponding to the whitelist behavior deletion information in the whitelist behavior basic information.

In the embodiment of the disclosure, if the whitelist behavior deletion information is received, specified behavior information (i.e., feature behavior information) may be deleted in the whitelist behavior basic information.

For example, if the whitelist behavior addition information is “w-modifying com interface”, where “w” may indicate the whitelist behavior basic information, “−” may indicates a deletion operation and “modifying com interface” may be feature behavior information, then a behavior of modifying com interface is deleted in the whitelist behavior basic information.

In an alternative example of the embodiment of the disclosure, the sub-step S25 may comprise the following sub-steps:

sub-step S253, modifying feature behavior information in the whitelist behavior basic information according to the whitelist behavior modification information.

In the embodiment of the disclosure, if the whitelist behavior modification information is received, specified behavior information (i.e., feature behavior information) in the whitelist behavior basic information may be modified.

For example, if the whitelist behavior basic information comprises access network (url:*), and the whitelist behavior modification information is “w|accessing network (url: hao.360.cn)”, where “w” may indicate the whitelist behavior basic information, “|” may indicate a modification operation and “accessing network (url: hao.360.cn)” may be modified information, then a behavior of accessing network (url: *) is modified to accessing network (url: hao.360.cn) in the whitelist behavior basic information.

In an alternative example of the embodiment of the disclosure, the sub-step S25 may comprise the following sub-steps:

sub-step S254, adding feature behavior information corresponding to the blacklist behavior addition information in the blacklist behavior basic information.

In the embodiment of the disclosure, if the blacklist behavior modification information is received, specified behavior information (i.e., feature behavior information) may be added in the blacklist behavior basic information.

For example, if the whitelist behavior addition information is “b+adding a drive program”, where “b” may indicate the blacklist behavior basic information, “+” may indicate an addition operation and “adding a drive program” may be feature behavior information, then a behavior of adding a drive program is added in the blacklist behavior basic information.

In an alternative example of the embodiment of the disclosure, the sub-step S25 may comprise the following sub-steps:

sub-step S255, deleting feature behavior information corresponding to the blacklist behavior deletion information in the blacklist behavior basic information.

In the embodiment of the disclosure, if the blacklist behavior deletion information is received, specified behavior information (i.e. feature behavior information) may be deleted in the blacklist behavior basic information.

For example, if the blacklist behavior deletion information is “b-sending a mail”, where “b” may indicate the blacklist behavior basic information, “−” may indicate a deletion operation and “sending a mail” may be feature behavior information, then a behavior of sending a mail is deleted in the blacklist behavior basic information.

In an alternative example of the embodiment of the disclosure, the sub-step S25 may comprise the following sub-steps:

sub-step S256, modifying feature behavior information in the blacklist behavior basic information according to the blacklist behavior modification information.

In the embodiment of the disclosure, if the blacklist behavior modification information is received, specified behavior information (i.e. feature behavior information) in the blacklist behavior basic information may be modified.

For example, if the blacklist behavior basic information comprises deleting an application program (Id: *) and the blacklist behavior modification information is “b| deleting an application program (Id: security tool)”, where “b” may indicate the blacklist behavior basic information, “|” may indicate a modification operation and “deleting an application program” may be feature behavior information, a behavior of deleting the application program (Id: *) is modified to deleting the application program (Id: security tool) in the blacklist behavior basic information.

Of course, the above behavior authorization configuration information only serves as an example. When implementing the embodiment of the disclosure, other behavior authorization configuration information may be set according to actual circumstances, and the embodiment of the disclosure will not make any limitations hereto. In addition, besides the above behavior authorization configuration information, a person skilled in the art can also use other behavior authorization configuration information according to actual requirements, and the embodiment of the disclosure will not make any limitations hereto.

It should be noted that a person skilled in the art can determine, according to actual circumstances, behaviors of which application programs are authentic and behaviors of which application programs are unauthentic, and the embodiment of the disclosure will not make any limitations hereto.

Sub-step 102, monitoring behavior information of the application program.

During actual applications, since the process of an application program generally implements operations on resources such as register tables, files and creation of other processes and so on by an API (Application Program Interface) function provided by an operation system, the object of monitoring can be achieved by performing Hook on these APIs invoked by the process.

To enable a person skilled in the art to better understand the embodiment of the disclosure, descriptions are made below by using a windows operation system as an example of API Hook and service system Hook.

Generally, Hook may be divided into user mode API Hook and service system Hook.

For the API Hook:

An LAT (import address table) is an important constituent part in a file in Portable Executable (PE) format under a windows platform, in which names of all system APIs that are possibly invoked in the PE file execution process are stored. At the time of running of the process of an application program, its executable file is invoked into memory, and meanwhile a PAI name of its IAT table will be mapped to a function body entrance address of a corresponding API in a current process control, and an API invoke made later by the process skips to the corresponding API function body by means of the IAT table.

Thus, the IAT table may be modified at the time of loading of the process, so as to divert an entrance address of an API to be intercepted to a new segment of code. This segment of code first records a function name and a parameter invoked by the API, and then diverts to the original real address of the API to continue the execution. That is, the object of re-directing the API can be achieved by modifying an entrance address of an API function in an IAT of a memory map of the application program.

For example, API functions that operate register tables, files and creation of other processes are as shown in Table 1.

TABLE 1

| Object | Operation | API Function |
|---|---|---|
| Register | Creating and Opening | RegCreateKeyEx, RegOpenKeyEx |
| Table | Register Table | |
| | Reading Register Table | RegQueryInfoKey, |
| | | RegQueryValue |
| | Writing Register Table | RegSetValueEx |
| | Deleting Register Table | RegDeleteKey, RegDeleteValue |
| File | Creating and Opening | CreatFile |
| | File | |
| | Reading and Writing | ReadFile, WriteFile |
| | File | |
| | File Deletion | DeleteFile |
| | File Re-naming | SHFileOperation |
| Progress | Creating Process | CreateProcess |
| | Opening Process | OpenProcess |

For the service system Hook:

Windows operation modes are divided into a user mode and a kernel mode. All invokes of application programs APIs in the user mode enter the kernel mode by invoking a local system service based on NTDLL.dll, seek for desired service function entrance addresses in corresponding system service tables according to loaded system service numbers by a system service scheduling table, and finally invoke system services in the kernel mode to perform real operations.

Thus, by Hooking system services to be monitored in the system service table to modify a system service function pointer required to be monitored in the system service table to point to a self-defined system service function, access control within the range of the whole system can be implemented.

For example, service functions that operate register tables, files and creation of other processes are as shown in Table 2.

TABLE 2

| Object | Operation | API Function |
|---|---|---|
| Register | Creating and Opening | ZwCreateKey, ZwOpenKey |
| Table | Register Table | |
| | Reading Register | ZwQueryInfoKey, ZwQuery Value |
| | Table | |
| | Writing Register Table | ZwSetValueEx |
| | Deleting Register | ZwDeleteKey, ZwDeleteValue |
| | Table | |
| File | Creating and Opening | ZwCreatFile, ZwOpenFile |
| | File | |
| | Reading and Writing | ZwReadFile, ZwWriteFile |
| | File | |
| | File Deletion | ZwSetInformationFile |
| | File Re-naming | ZwSetInformationFile |
| Progress | Creating Process | ZwCreateProcess, ZwCreateProcess |
| | Opening Process | ZwOpenProcess |

Step 103, processing the behavior information according to the behavior authorization information.

In the embodiment of the disclosure, upon receipt of the behavior authorization information returned by the server, the client can monitor behaviors of the application process according to configurations for authorizations of behaviors in the behavior authorization information.

In an alternative embodiment of the disclosure, the step 103 may comprise the following sub-steps:

sub-step S31, when the behavior information matches with feature behavior information in the behavior authorization information, performing an operation corresponding to the feature behavior information.

By applying the embodiment of the disclosure, a corresponding processing manner may be configured in advance for the feature behavior information of the application program.

When behavior information corresponding to the feature behavior information is detected, processing may be performed according to the processing manner set in advance.

In an alternative embodiment of the disclosure, the sub-step S31 may comprise the following sub-steps:

sub-step S311, when the behavior information matches with feature behavior information in the whitelist behavior information, allowing execution of the behavior information.

In the embodiment of the disclosure, feature behavior information of an authentic behavior, which has an executable authorization, may be recorded in the whitelist behavior information.

When it is detected that a behavior of a current application program matches with feature behavior information in the whitelist behavior information, the execution of the behavior is allowed according to the executable authorization.

In an alternative embodiment of the disclosure, the sub-step S31 may comprise the following sub-steps:

sub-step S312, when the behavior information matches with feature behavior information in the blacklist behavior information, generating first prompt information with respect to the behavior information.

In the embodiment of the disclosure, feature behavior information of an unauthentic behavior, which has a non-executable authorization, may be recorded in the blacklist behavior information.

When it is detected that a behavior of a current application program matches with feature behavior information in the blacklist behavior information, the execution of the behavior is intercepted according to the non-executable authorization, and first prompt information is generated; for example, text information “Application program C is sending a mail, possibly stealing passwords, whether to prevent” is generated, and a red background color and controls “YES” and “NO” are configured, so as to prompt a user that a dangerous behavior is being executed.

If an operation instruction of allowing execution which is returned with respect to the first prompt information is received, for example, the user clicks the control “NO”, the execution of the behavior may be allowed.

If an operation instruction of prohibiting execution which is returned with respect to the first prompt information is received, for example, the user clicks the control “YES”, the execution of the behavior is intercepted.

The embodiment of the disclosure performs authentic and unauthentic operations on behaviors of an application program according to whitelist behavior information and blacklist behavior information, so as to further fine the hierarchy of authority, thereby improving the accuracy of behavior monitoring.

In an alternative embodiment of the disclosure, the step 103 may comprise the following sub-steps:

sub-step S41, when the behavior information does not match with feature behavior information in the behavior authorization information, generating second prompt information with respect to the behavior information.

In the implementation of the disclosure, if a behavior of the application program is not recorded previously in the behavior authorization information, for example neither matches with the feature behavior information in the whitelist behavior information nor matches with the feature behavior information in the blacklist behavior information, the client may generate second prompt information with respect to the behavior, for example “application program D is modifying system sensitive startup items, whether to prevent”, so as to prompt the user that a behavior sensitive is being executed.

If an operation instruction of allowing execution which is returned with respect to the second prompt information is received, for example, the user clicks the control “NO”, the execution of the behavior may be allowed.

If an operation instruction of prohibiting execution which is returned with respect to the second prompt information is received, for example, the user clicks the control “YES”, the execution of the behavior is intercepted.

In an alternative embodiment of the disclosure, the step 103 may comprise the following sub-steps S51-S53.

Sub-step S51, when the behavior information does not match with feature behavior information in the behavior authorization information, sending information of the application program and the behavior information to a server.

Sub-step S52, receiving operation information with respect to the information of the application program and the behavior information, which is returned by the server.

Sub-step S53, performing an operation according to the operation information.

In the implementation of the disclosure, if a behavior of the application program is not recorded previously in the behavior authorization information, for example neither matches with the feature behavior information in the whitelist behavior information nor matches with the feature behavior information in the blacklist behavior information, the client uploads related conditions of the behavior to the server, the server performs processing and returns operation information, and the client performs operations according to the returned operation information.

For example, when the server obtains through analysis that the current behavior possibly reads account passwords of the user such that it is highly dangerous, blocking (an example of freezing and locking behaviors) may be returned, and the client intercepts the execution of the behavior according to the blocking.

The embodiment of the disclosure gives a prompt as to an unmarked behavior, or, analyzes an unmarked behavior by a server, thereby further improving the accuracy and the comprehensiveness of behavior monitoring.

The embodiment of the disclosure acquires behavior authorization information corresponding to an application program when a startup operation of the application program is detected, processes monitored behavior information of the application program according to the behavior authorization information, monitors an application program taking a single behavior as an authorization unit by configuring authorization information for behaviors, thus avoiding monitoring leaks caused by uniform configuration of authorization for the application program in a whitelist and a backlist, so as to realize fine-gained authorization control, enhance the strength of protection, reduce potential threats, and also make it possible to reduce a false alarm rate.

To simplify descriptions, all method embodiments are expressed as a series of action combinations. However, a person skilled in the art should appreciate that the embodiments of the disclosure are not limited to the action order as described for the following reasons: in accordance with the embodiment of the disclosure, some steps may be performed in other orders or simultaneously; moreover, a person skilled in the art should also appreciate that all the embodiments as described in the description are preferred embodiments, and the actions involved are not necessarily needed for the embodiments of the disclosure.

Referring to FIG. 2, a block schematic view of an embodiment of a behavior processing device based on application program according to one embodiment of the disclosure, which may specifically comprise the following modules, is schematically illustrated:

an authorization information 201 acquiring module adapted to, when a startup operation of an application program is detected, acquire behavior authorization information corresponding to the application program;

a behavior information monitoring module 202 adapted to monitor behavior information of the application program; and

a processing module 203 adapted to process the behavior information according to the behavior authorization information.

In a preferred embodiment of the disclosure, the authorization information acquiring module 201 may be further adapted to:

extract first feature information of the application program;

send the first feature information to a server; and

receive behavior authorization information corresponding to preset second feature information, which is returned by the server when it is judged that the first feature information matches with the second feature information.

In a preferred embodiment of the disclosure, the authorization information acquiring module 201 may be further adapted to:

extract first feature information of the application program;

send the first feature information to a server; and

receive behavior authorization configuration information and an authorization group identifier corresponding to preset second feature information, which are returned by the server when it is judged that the first feature information matches with the second feature information;

seek for behavior authorization basic information corresponding to the authorization group identifier, which is preset locally; and

perform configuration on the behavior authorization basic information using the behavior authorization configuration information so as to obtain the behavior authorization information.

In a preferred embodiment of the disclosure, the behavior authorization information comprises at least one of whitelist behavior information and blacklist behavior information;

the behavior authorization configuration information may comprise at least one of whitelist behavior addition information, whitelist behavior deletion information, whitelist behavior modification information, blacklist behavior addition information, blacklist behavior deletion information, and blacklist behavior modification information; and

the behavior authorization basic information may comprise at least one of whitelist behavior basic information and blacklist behavior basic information.

In a preferred embodiment of the disclosure, the authorization information acquiring module 201 may be further adapted to:

add feature behavior information corresponding to the whitelist behavior addition information in the whitelist behavior basic information.

In a preferred embodiment of the disclosure, the authorization information acquiring module 201 may be further adapted to:

delete feature behavior information corresponding to the whitelist behavior deletion information in the whitelist behavior basic information.

In a preferred embodiment of the disclosure, the authorization information acquiring module 201 may be further adapted to:

modify feature behavior information in the whitelist behavior basic information according to the whitelist behavior modification information.

In a preferred embodiment of the disclosure, the authorization information acquiring module 201 may be further adapted to:

add feature behavior information corresponding to the blacklist behavior addition information in the blacklist behavior basic information.

In a preferred embodiment of the disclosure, the authorization information acquiring module 201 may be further adapted to:

delete feature behavior information corresponding to the blacklist behavior deletion information in the blacklist behavior basic information.

In a preferred embodiment of the disclosure, the authorization information acquiring module 201 may be further adapted to:

modify feature behavior information in the blacklist behavior basic information according to the blacklist behavior modification information.

In a preferred embodiment of the disclosure, the processing module 203 may be further adapted to:

when the behavior information matches with feature behavior information in the behavior authorization information, perform an operation corresponding to the feature behavior information.

In a preferred embodiment of the disclosure, the processing module 203 may be further adapted to:

when the behavior information matches with feature behavior information in the whitelist behavior information, allow execution of the behavior information.

In a preferred embodiment of the disclosure, the processing module 203 may be further adapted to:

when the behavior information matches with feature behavior information in the blacklist behavior information, generate first prompt information with respect to the behavior information.

In a preferred embodiment of the disclosure, the processing module 203 may be further adapted to:

when the behavior information does not match with feature behavior information in the behavior authorization information, generate second prompt information with respect to the behavior information.

In a preferred embodiment of the disclosure, the processing module 203 may be further adapted to:

when the behavior information does not match with feature behavior information in the behavior authorization information, send information of the application program and the behavior information to a server;

receive operation information with respect to the information of the application program and the behavior information, which is returned by the server; and

perform an operation according to the operation information.

As to device embodiments, the device embodiments are relatively simply described since they are essentially similar to the method embodiments, and for related parts, please refer to the descriptions made in the part of the method embodiments.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the behavior processing device based on application program according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

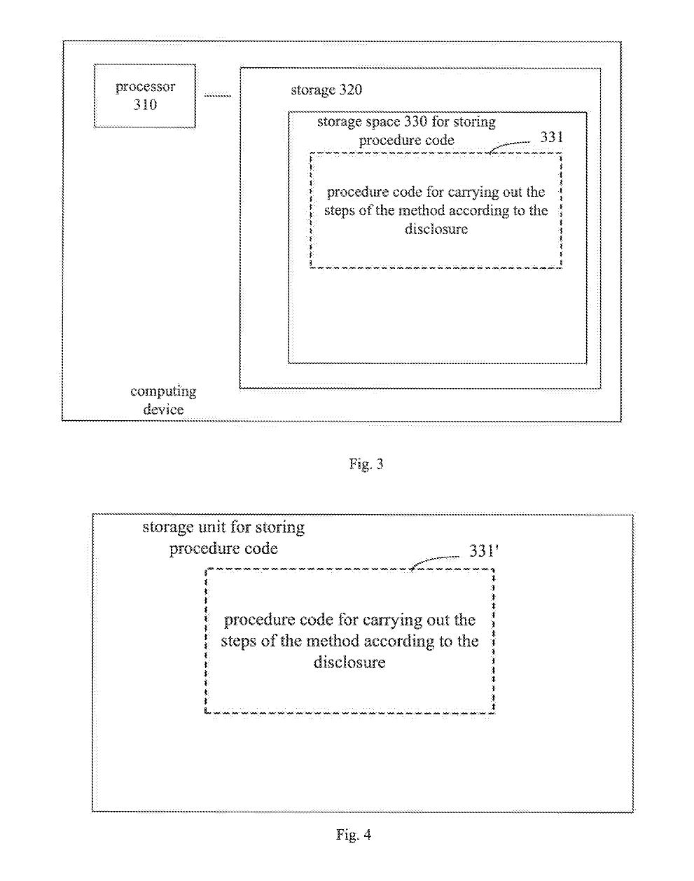

For example, FIG. 3 shows a computing device, e.g. an application server, for executing the behavior processing based on application program according to the disclosure. The computing device traditionally comprises a processor 310 and a computer program product or a computer readable medium in the form of storage 320. The storage 320 can be electronic storage such as flash memory, EEPROM (Electrically Erasable Programmable Read-Only Memory), EPROM, hard disk or ROM, and the like. Storage 320 possesses storage space 330 for carrying out procedure code 331 of any steps of aforesaid method. For example, storage space 330 for storing procedure code can comprise various procedure codes 331 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 4. The storage cell can possess memory paragraph, storage space like the storage 320 in the computing device in FIG. 3. The procedure code can be compressed in, for example, a proper form. Generally, storage cell comprises computer readable code 331′, i.e. the code can be read by processors such as 310 and the like. When the codes run on a computer device, the computer device will carry out various steps of the method described above.

The “an embodiment”, “embodiments” or “one or more embodiments” referred here mean being included in at least one embodiment in the disclosure combining specific features, structures or features described in the embodiments. In addition, please note that the phrase “in an embodiment” not necessarily mean a same embodiment.

The description provided here explains plenty of details. However, it can be understood that the embodiments of the disclosure can be implemented without these specific details. The known methods, structure and technology are not shown in detail in some embodiments, so as not to obscure the understanding of the description.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the devices can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

1.-32. (canceled)

33. A behavior processing method based on application program, comprising steps of:
when a startup operation of an application program is detected, acquiring behavior authorization information corresponding to the application program;
monitoring behavior information of the application program; and
processing the behavior information according to the behavior authorization information.

34. The method according to claim 33, wherein, the step of acquiring behavior authorization information corresponding to the application program comprises:
extracting first feature information of the application program;
sending the first feature information to a server; and
receiving behavior authorization information corresponding to preset second feature information, which is returned by the server when judging that the first feature information matches with the second feature information.

35. The method according to claim 33, wherein, the step of acquiring behavior authorization information corresponding to the application program comprises:
extracting first feature information of the application program;
sending the first feature information to a server; and
receiving behavior authorization configuration information and an authorization group identifier corresponding to preset second feature information, which are returned by the server when it is judged that the first feature information matches with the second feature information;
seeking for behavior authorization basic information corresponding to the authorization group identifier, which is preset locally; and
performing configuration on the behavior authorization basic information using the behavior authorization configuration information so as to obtain the behavior authorization information.

36. The method according to claim 35, wherein, the behavior authorization information comprises at least one of whitelist behavior information and blacklist behavior information;
the behavior authorization configuration information comprises at least one of whitelist behavior addition information, whitelist behavior deletion information, whitelist behavior modification information, blacklist behavior addition information, blacklist behavior deletion information, and blacklist behavior modification information; and
the behavior authorization basic information comprises at least one of whitelist behavior basic information and blacklist behavior basic information.

37. The method according to claim 36, wherein, the step of performing configuration on the behavior authorization basic information using the behavior authorization configuration information so as to obtain the behavior authorization information comprises:
adding feature behavior information corresponding to the whitelist behavior addition information in the whitelist behavior basic information;
deleting feature behavior information corresponding to the whitelist behavior deletion information in the whitelist behavior basic information;
modifying feature behavior information in the whitelist behavior basic information according to the whitelist behavior modification information;
adding feature behavior information corresponding to the blacklist behavior addition information in the blacklist behavior basic information;
deleting feature behavior information corresponding to the blacklist behavior deletion information in the blacklist behavior basic information; or
modifying feature behavior information in the blacklist behavior basic information according to the blacklist behavior modification information.

38. The method according to claim 36, wherein, the step of processing the behavior information according to the behavior authorization information comprises:
when the behavior information matches with feature behavior information in the behavior authorization information, performing an operation corresponding to the feature behavior information.

39. The method according to claim 38, wherein, the step of, when the behavior information matches with feature behavior information in the behavior authorization information, performing an operation corresponding to the feature behavior information, comprises:
when the behavior information matches with feature behavior information in the whitelist behavior information, allowing execution of the behavior information.

40. The method according to claim 38, wherein, the step of, when the behavior information matches with feature behavior information in the behavior authorization information, performing an operation corresponding to the feature behavior information, comprises:
when the behavior information matches with feature behavior information in the blacklist behavior information, generating first prompt information with respect to the behavior information.

41. The method according to claim 33, wherein, the step of processing the behavior information according to the behavior authorization information comprises:
when the behavior information does not match with feature behavior information in the behavior authorization information, generating second prompt information with respect to the behavior information.

42. The method according to claim 33, wherein, the step of processing the behavior information according to the behavior authorization information comprises:
when the behavior information does not match with feature behavior information in the behavior authorization information, sending information of the application program and the behavior information to a server;
receiving operation information with respect to the information of the application program and the behavior information, which is returned by the server; and
performing an operation according to the operation information.

43. A behavior processing device based on application program, comprising:
one or more processors; and
a memory;
wherein one or more programs are stored in the memory, and when executed by the one or more processors, the one or more programs cause the one or more processors to:
when a startup operation of an application program is detected, acquire behavior authorization information corresponding to the application program;
monitor behavior information of the application program; and
process the behavior information according to the behavior authorization information.

44. The device according to claim 43, wherein the one or more processors are further caused to:
extract first feature information of the application program;
send the first feature information to a server; and
receive behavior authorization information corresponding to preset second feature information, which is returned by the server when it is judged that the first feature information matches with the second feature information.

45. The device according to claim 43, wherein the one or more processors are further caused to:
extract first feature information of the application program;
send the first feature information to a server; and
receive behavior authorization configuration information and an authorization group identifier corresponding to preset second feature information, which are returned by the server when it is judged that the first feature information matches with the second feature information;
seek for behavior authorization basic information corresponding to the authorization group identifier, which is preset locally; and
perform configuration on the behavior authorization basic information using the behavior authorization configuration information so as to obtain the behavior authorization information.

46. The device according to claim 45, wherein the behavior authorization information comprises at least one of whitelist behavior information and blacklist behavior information;
the behavior authorization configuration information comprises at least one of whitelist behavior addition information, whitelist behavior deletion information, whitelist behavior modification information, blacklist behavior addition information, blacklist behavior deletion information, and blacklist behavior modification information; and
the behavior authorization basic information comprises at least one of whitelist behavior basic information and blacklist behavior basic information.

47. The device according to claim 46, wherein, the one or more processors are further caused to:
add feature behavior information corresponding to the whitelist behavior addition information in the whitelist behavior basic information;
delete feature behavior information corresponding to the whitelist behavior deletion information in the whitelist behavior basic information;
modify feature behavior information in the whitelist behavior basic information according to the whitelist behavior modification information;
add feature behavior information corresponding to the blacklist behavior addition information in the blacklist behavior basic information;
delete feature behavior information corresponding to the blacklist behavior deletion information in the blacklist behavior basic information; or
modify feature behavior information in the blacklist behavior basic information according to the blacklist behavior modification information.

48. The device according to claim 46, the one or more processors are further caused to:
when the behavior information matches with feature behavior information in the behavior authorization information, perform an operation corresponding to the feature behavior information.

49. The device according to claim 48, wherein, the one or more processors are further caused to:
when the behavior information matches with feature behavior information in the whitelist behavior information, allow execution of the behavior information, or
when the behavior information matches with feature behavior information in the blacklist behavior information, generate first prompt information with respect to the behavior information.

50. The device according to claim 43, wherein the one or more processors are further caused to:
when the behavior information does not match with feature behavior information in the behavior authorization information, generate second prompt information with respect to the behavior information.

51. The device according to claim 43, wherein the one or more processors are further caused to:
when the behavior information does not match with feature behavior information in the behavior authorization information, send information of the application program and the behavior information to a server;
receive operation information with respect to the information of the application program and the behavior information, which is returned by the server; and
perform an operation according to the operation information.

52. A non-transitory computer-readable medium having computer programs stored thereon that, when executed by one or more processors of an electronic device, cause the electronic device to perform operations for processing behavior based on application program, the operations comprising:
when a startup operation of an application program is detected, acquiring behavior authorization information corresponding to the application program;
monitoring behavior information of the application program; and
processing the behavior information according to the behavior authorization information.
